(19) United States
(12) Patent Application Publication
(10) Pub. No.: US 2009/0256790 A1
(43) Pub. Date: Oct. 15, 2009

(54) Liquid crystal display having dynamic backlighting

(75) Inventor: Chih-Chung Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/384,815

(22) Filed: Apr. 9, 2009

(30) Foreign Application Priority Data
Apr. 9, 2008 (CN) 200810066519.4

(51) Int. Cl. G09G 3/36; G02F 1/1335

(52) U.S. Cl. 345/89; 345/102; 349/65

(57) ABSTRACT

A liquid crystal display includes a liquid crystal panel for displaying images, a light guide plate, and light sources. The light guide plate includes light emitting areas. The light sources provide light to the corresponding light emitting areas respectively. When an area of the liquid crystal panel corresponding to a light emitting area of the light guide plate displays a high brightness gray level, the corresponding light source provides light with high brightness. When an area of the liquid crystal panel corresponding to a light emitting area of the light guide plate displays a low brightness gray level, the corresponding light source provides light with low brightness.

### BACKGROUND

1. Technical Field

The present invention relates to liquid crystal displays (LCDs), and particularly to an LCD with dynamic backlighting.

2. Description of Related Art

LCDs are commonly used as displays for compact electronic apparatuses. This is because LCDs not only provide good quality images using little power, but are also conveniently thin. Because liquid crystal in an LCD does not emit any light itself, the LCD requires a light source to clearly and sharply display text and images. Therefore, LCDs typically require a backlight module.

Referring to FIG. 5, a related art LCD 1 includes a liquid crystal panel (not shown) and a backlight module 10 provided for illuminating the liquid crystal panel. The backlight module 10 includes a diffusing film 11, a light guide plate 12, a reflective film 13, a printed circuit board (PCB) 14, and a plurality of light emitting diodes (LEDs) 15. The diffusing film 11, the light guide plate 12, and the reflective film 13 are disposed in that order from top to bottom. The LEDs 15 are arranged on the PCB 14, and are electrically connected in series or in parallel. The PCB 14 drives the LEDs 15 to emit light.

The light guide plate 12 includes a top light emitting surface 121, a bottom surface 122, and a light incident surface 123. The light incident surface 123 adjoins the light emitting surface 121 perpendicularly. The LEDs 15 are disposed adjacent to the light incident surface 123.

With the development of various display technologies, dynamic contrast ratio (DCR) technology which enhances the contrast ratio of an LCD is now widely used. In applying DCR to the LCD 1, when an average brightness of gray levels of the image is high, the backlight module 10 increases its brightness, and vice versa. However, the backlight module 10 can only provide this kind of brightness adjustment for the image displayed on the liquid crystal panel as a whole. When an average brightness of gray levels of part of the image is high, and an average brightness of gray levels of another part of the image is low, an increase or decrease in the brightness of the backlight module 10 can only enhance the DCR performance of one the image parts, with the DCR performance of the other image part frequently being unsatisfactory.

What is needed, therefore, is an LCD that can overcome the above-described deficiencies.

### BRIEF DESCRIPTION OF THE DRAWINGS

FIG. 1 is an exploded, isometric view of an LCD according to a first embodiment of the present invention, the LCD including a backlight module, the backlight module including a light guide plate and four light sources.

FIG. 2 is an exploded, isometric view illustrating an arrangement of the four light sources and the light guide plate of FIG. 1.

FIG. 3 is a top plan view of part of an LCD according to a second embodiment of the present invention, illustrating an arrangement of six light sources and a light guide plate of the LCD.

FIG. 4 is similar to FIG. 3, but showing an arrangement of eight light sources and a light guide plate of an LCD according to a third embodiment of the present invention.

FIG. 5 is an exploded, isometric view of a conventional LCD.

### DETAILED DESCRIPTION

Reference will now be made to the drawings to describe various embodiments of the present invention in detail.

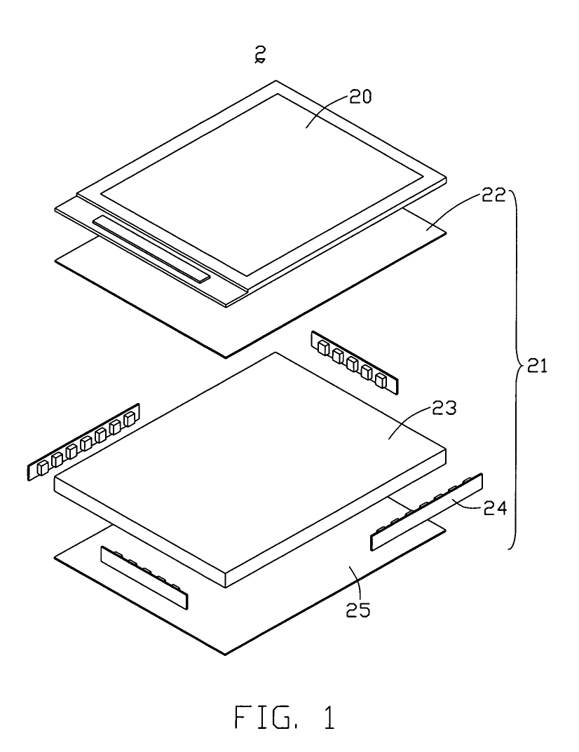

FIG. 1 is an isometric view of an LCD according to a first embodiment of the present invention. The LCD 2 includes a liquid crystal panel 20, and a backlight module 21 provided for illuminating the liquid crystal panel 20. The liquid crystal panel 20 is configured for displaying images with a plurality of gray levels. The backlight module 21 includes a diffusing film 22, a light guide plate 23, four light sources 24, and a reflective film 25. The liquid crystal panel 20, the diffusing film 22, the light guide plate 23, and the reflective film 25 are disposed in that order from top to bottom. That is, the diffusing film 22 is disposed between the light guide plate 23 and the liquid crystal panel 20, and the light guide plate 23 is disposed between the diffusing film 22 and the reflective film 25.

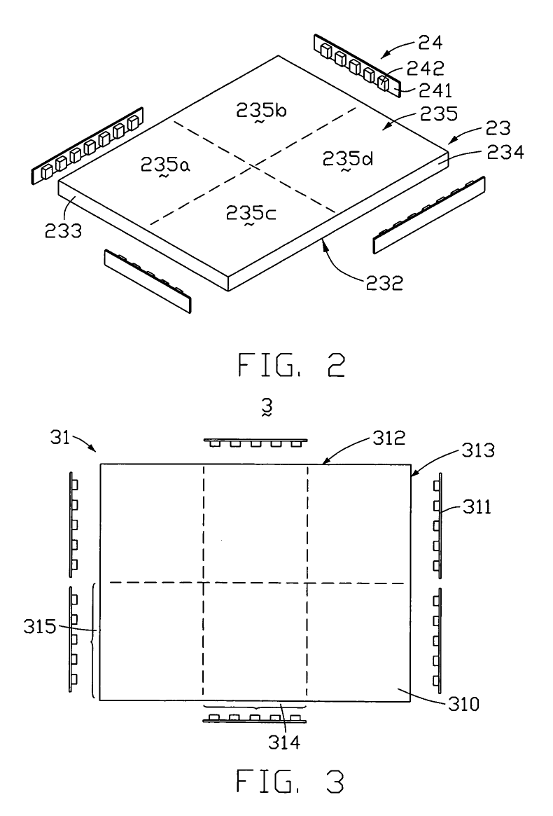

Referring also to FIG. 2, the light guide plate 23 includes four light emitting areas 235a, 235b, 235c, 235d, a bottom surface 232, and four side surfaces 233. The four light emitting areas 235a, 235b, 235c, 235d cooperatively define a top light emitting surface 235. The light emitting surface 235 is generally parallel to the bottom surface 232. The four side surfaces 233 are connected with each other end to end, and adjoin the light emitting surface 235 perpendicularly. Each side surface 233 includes a light incident area 234. A length of each light incident area 234 is half of a length of the corresponding side surface 233. Each of the four light emitting areas 235a, 235b, 235c, 235d corresponds to a respective light incident area 234.

Each light source 24 includes a PCB 241 and a plurality of LEDs 242. The LEDs 242 are arranged on the PCB 241 along a longitudinal direction. The four light sources 24 are disposed adjacent to the corresponding four light incident areas 234, respectively. A length of each light source 24 is generally equal to the length of the light incident area 234. The brightness of each of the four light sources 24 can be individually controlled.

The light emitting from the four light sources 24 enters the light guide plate 23 through the corresponding light incident areas 234. The light guide plate 23 transforms the incident light into planar light which emits from the light emitting surface 235. The planar light then enters the liquid crystal panel 20 to illuminate the liquid crystal panel 20. When an average brightness of gray levels of a first part of an image of the liquid crystal panel 20 is high, for example, the first part of the image corresponding to the light emitting area 235a, then the brightness of the light source 24 corresponding to the light emitting area 235a increases. When an average brightness of gray levels of a second part of the image of the liquid crystal panel 20 is simultaneously low, for example, the second part of the image corresponding to the light emitting area 235d, then the brightness of the light source 24 corresponding to the light emitting area 235d decreases. Thus, the first part of the image gains an even higher brightness while the second part of the image gains an even lower brightness. Accordingly, unlike in a conventional LCD, the LCD 2 can have good DCR performance.

Referring to FIG. 3, an LCD 3 according to a second embodiment of the present invention is similar to the LCD 2. However, a backlight module 31 includes a light guide plate 310 and six light sources 311. The light guide plate 310 includes two first side surfaces 312 at two opposite sides thereof, two second side surfaces 313 at another two opposite sides thereof, and six light emitting areas (not labeled). Each first side surface 312 includes a first light incident area 314. The first light incident area 314 is located at a middle part of the first side surface 312, and has a length of one third of the first side surface 312. Each second side surface 313 includes two second light incident areas 315. The two second light incident areas 315 are located adjacent to each other; one at a left half of the second side surface 313, and the other one at a right half of the second side surface 313. That is, a length of each second light incident area 315 is substantially half a length of the second side surface 313. The six light emitting areas cooperatively define a light emitting surface (not labeled). Each light emitting area occupies an area of one-sixth of the whole area of the light emitting surface. The six light emitting areas correspond to the six light incident areas (two first light incident areas 314 and four second light incident areas 315), respectively. The LCD 3 has advantages similar to those of the LCD 2.

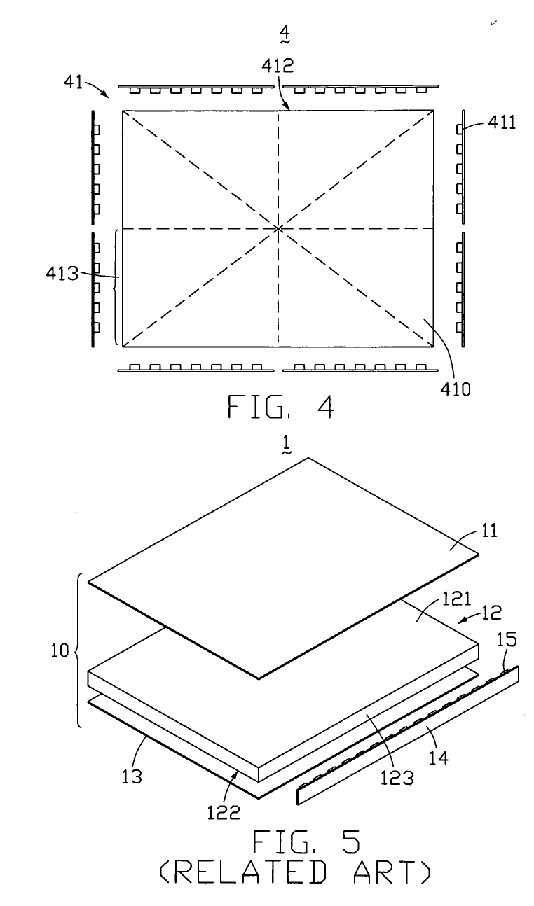

Referring to FIG. 4, an LCD 4 according to a third embodiment of the present invention is similar to the LCD 3. However, a backlight module 41 includes a light guide plate 410 and eight light sources 411. The light guide plate 410 includes four side surfaces 412 and eight light emitting areas (not labeled). Each side surface 412 includes two light incident areas 413. The two light incident areas 413 are located adjacent to each other; one at a left half of the side surface 412, and the other one at a right half of the side surface 412. That is, a length of each light incident area 413 is substantially half a length of the side surface 412. The eight light emitting areas define a light emitting surface (not labeled). Each light emitting area occupies an area by one-eighth of the whole area of the light emitting surface. The eight light emitting areas correspond to the eight light incident areas 413, respectively. The LCD 4 has advantages similar to those of the LCD 2.

It is to be understood that even though numerous characteristics and advantages of the present embodiments have been set out in the foregoing description, together with details of the structures and functions of the embodiments, the invention is illustrative only, and changes may be made in detail, especially in matters of shape, size, and arrangement of parts within the principles of the invention to the full extent indicated by the broad general meaning of the terms in which the appended claims are expressed.

1. A liquid crystal display (LCD), comprising:
a liquid crystal panel configured for displaying images with a plurality of gray levels;
a light guide plate, comprising a plurality of light emitting areas; and
a plurality of light sources positioned for providing light to areas of the light guide plate corresponding to the light emitting areas, respectively;
wherein when an area of the liquid crystal panel corresponding to one of the light emitting areas of the light guide plate displays image information wherein an average brightness of gray levels of the image information is high, the LCD is capable of adjusting the corresponding light source to provide light with high brightness, and when an area of the liquid crystal panel corresponding to one of the light emitting areas of the light guide plate displays image information wherein an average brightness of gray levels of the image information is low, the LCD is capable of adjusting the corresponding light source to provide light with low brightness.

2. The LCD of claim 1, wherein when one area of the liquid crystal panel corresponding to one of the light emitting areas of the light guide plate displays image information wherein an average brightness of gray levels of the image information is high, and simultaneously another area of the liquid crystal panel corresponding to another one of the light emitting areas of the light guide plate displays image information wherein an average brightness of gray levels of the image information is low, the LCD is capable of simultaneously adjusting one of said corresponding light sources to provide light with high brightness and the other of said corresponding light sources to provide light with low brightness.

3. The LCD of claim 2, wherein the plurality of light emitting areas adjoin each other and cooperatively define a single, continuous light emitting surface of the light guide plate.

4. The LCD of claim 2, wherein the light guide plate further comprises a plurality of side surfaces connected with each other end by end, and generally cross with the light emitting areas perpendicularly.

5. The LCD of claim 4, wherein each side surface of the light guide plate comprises at least a light incident area, each light source disposed adjacent to the corresponding light incident area.

6. The LCD of claim 5, wherein each side surface of the light guide plate comprises a light incident area and a length of the light incident area is half of a length of the corresponding side surface.

7. The LCD of claim 4, wherein the light guide plate comprises two first side surfaces opposite to each other and two second side surfaces opposite to each other, each first side surface comprising a first light incident area, each second side surface comprising two second light incident areas.

8. The LCD of claim 7, wherein each first light incident area is located at middle part of the first side surface, has a length of one third of that of the corresponding first side surface, and each second light incident areas has a half length of the corresponding second side surface.

9. The LCD of claim 4, wherein each side surface of the light guide plate comprises two light incident areas, and a length of the light incident area is half of a length of the corresponding side surface.

10. The LCD of claim 2, wherein the brightness of each light source is capable of being individually controlled by the LCD.

11. The LCD of claim 2, wherein each light source comprises a printed circuit board and a plurality of light emitting diodes arranged on the printed circuit board.

12. A liquid crystal display (LCD), comprising:
a liquid crystal panel configured for displaying images with a plurality of gray levels;
a light guide plate, comprising a plurality of light emitting areas; and
a plurality of light sources positioned for providing light to the light emitting areas, respectively;
wherein a brightness of each light source is capable of being individually controlled by the LCD, so that the brightness of each light emitting area is adjusted according to an average brightness of gray levels of a corresponding part of an image displayed by the liquid crystal panel.

13. The LCD of claim 12, wherein when an area of the liquid crystal panel corresponding to a light emitting area of the light guide plate displays a high brightness gray level, the corresponding light source provides light with high brightness, when an area of the liquid crystal panel corresponding to a light emitting area of the light guide plate displays a low brightness gray level, the corresponding light source provides light with low brightness.

14. The LCD of claim 13, wherein the light guide plate further comprises four side surfaces generally crossing with the light emitting areas perpendicularly.

15. The LCD of claim 14, wherein each side surface of the light guide plate comprises at least a light incident area, each light source disposed adjacent to the corresponding light incident area.

16. The LCD of claim 15, wherein each side surface of the light guide plate comprises a light incident area and a length of the light incident area is half of a length of the corresponding side surface.

17. The LCD of claim 15, wherein each side surface of the light guide plate comprises two light incident areas, and a length of the light incident area is half of a length of the corresponding side surface.

18. The LCD of claim 15, wherein the light guide plate comprises two first side surfaces opposite to each other and two second side surfaces opposite to each other, each first side surface comprising a first light incident area, each second side surface comprising two second light incident areas.

19. The LCD of claim 18, wherein each first light incident area is located at middle part of the first side surface, has a length of one third of that of the corresponding first side surface, and each second light incident areas has a half length of the corresponding second side surface.

20. The LCD of claim 12, wherein the light source comprises a printed circuit board and a plurality of light emitting diodes arranged thereon.
